(19) United States
(12) Patent Application Publication
(10) Pub. No.: US 2004/0123740 A1
(43) Pub. Date: Jul. 1, 2004

(54) Wall waterfall

(76) Inventor: Lovell Willis SR., Valley, AL (US)

Correspondence Address: Lovell Willis Sr., 405 West 8th Street, West Point, GA, 31833, US

(21) Appl. No.: 10/217,448

(22) Filed: Dec. 26, 2002

(51) Int. Cl. B01D 47/00

(52) U.S. Cl. 96/322

(57) ABSTRACT

The disclosure abstract for the Wallwaterfall. Like nature Dust particles are absorbed into the waterfall from the surrounding environment. My claim is that this unit clean the air indoor. It work the same as if it were Raining. It is good for respiratory illness. I have found only rain do what this fall do.

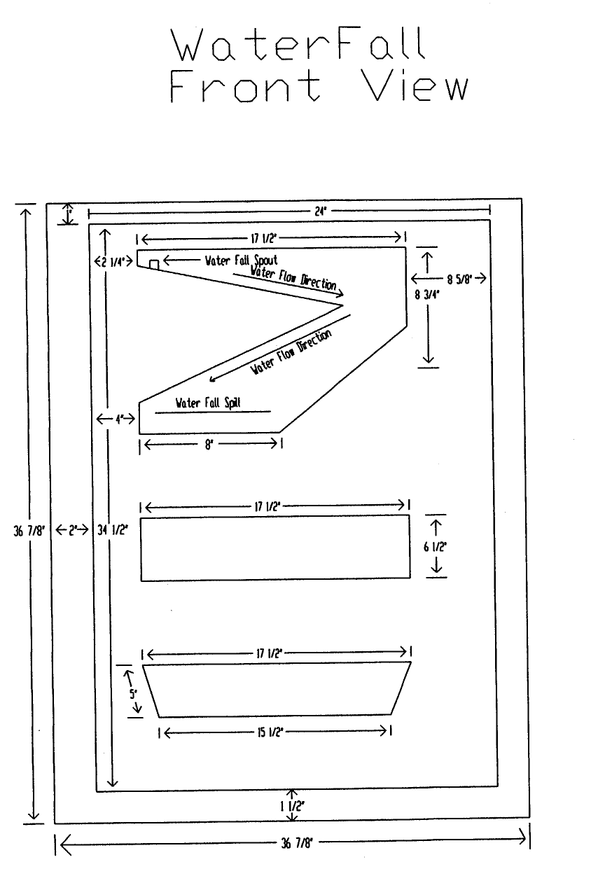

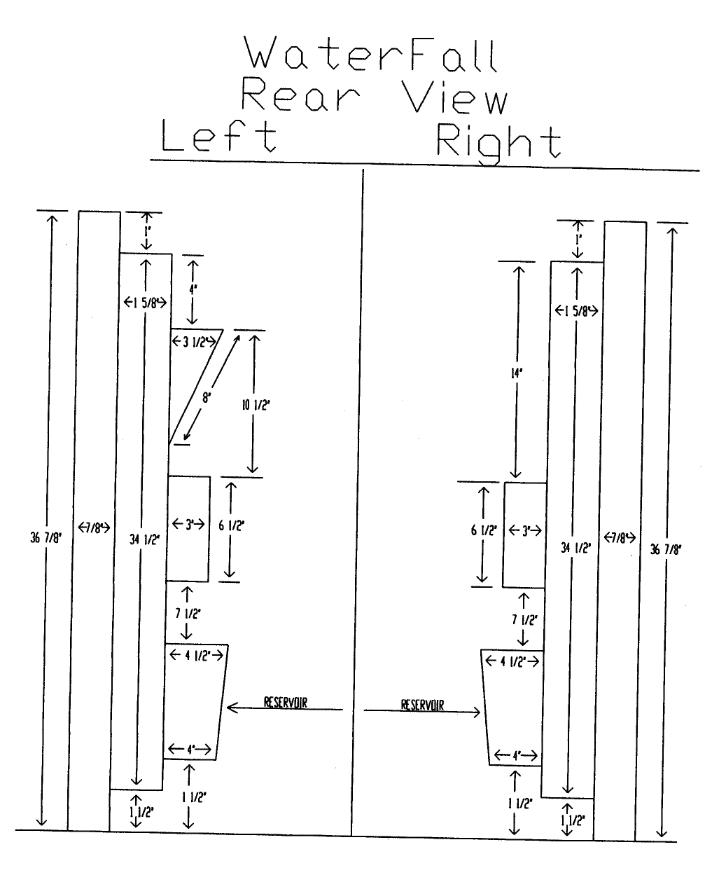

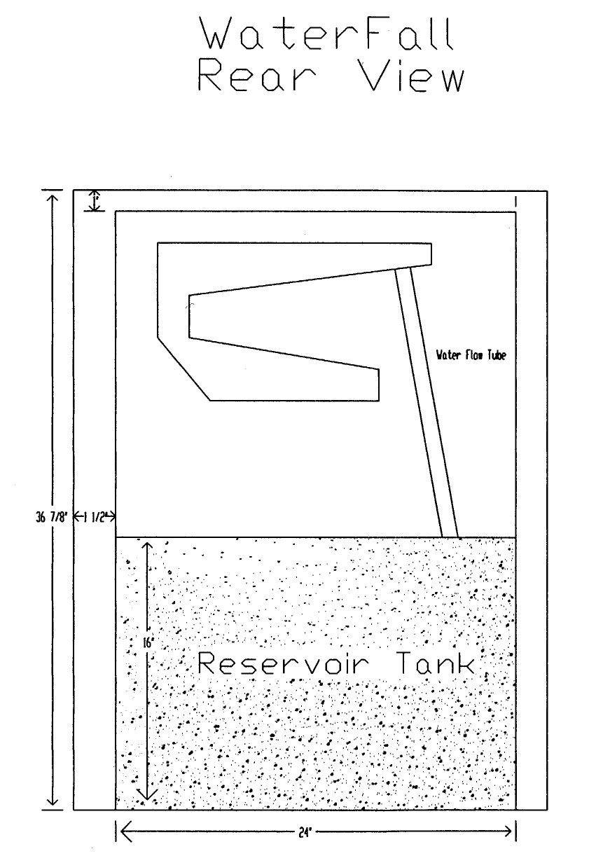

This wall waterfall is vacuum form using ABS 0.082 sheet plastic. The mold is made of fiber glass and heated to 400 degrees, to form And take the image of the mold design.

A water pump is added with a capacity of 80 gph for continuous Flow. A. ½×5 inch tube 2 feet long is attach in the rear of the unit For water transfer from the reservoir to top of fall. This unit is mostly wall mounted, but can be install indoor or outdoor.

Breathe Easy indoor waterfall relaxation system will reduce stress while improving your environment. Dust particles are absorbed into the waterfall which aids in the treatment of asthma and other respiratory illnesses. The sounds from the waterfall promote a more restful sleep.

This wall waterfall is vacuum formed using ABS 0.082 sheet plastic.

The mold is made of fiber glass and heated to 400 degrees, and takes the images of the mold design.

A water pump is added with a capacity of 80 gph for continuous Flow. A 5 inch tube 2 feet long is attach in the rear of the unit for water transfer from the reservoir to the top of the fall. This unit is mostly wall mounted, but can be installed indoors or outdoors in many arrangements on a vertical surface.

1. I claim this wall waterfall will improve indoor environment. It will remove dust particles from the air, clean air bound substances that are attracted to water, and improve asthma and other Respiratory illnesses.
